(19) United States
(12) Patent Application Publication
(10) Pub. No.: US 2024/0026654 A1
(43) Pub. Date: Jan. 25, 2024

(54) CONSTRUCTION MACHINE AND SUPPORT SYSTEM OF CONSTRUCTION MACHINE

(71) Applicant: SUMITOMO HEAVY INDUSTRIES, LTD., Tokyo (JP)

(72) Inventor: Keisuke SATOH, Kanagawa (JP)

(21) Appl. No.: 18/475,608

(22) Filed: Sep. 27, 2023

Related U.S. Application Data
(63) Continuation of application No. PCT/JP2022/016306, filed on Mar. 30, 2022.

(30) Foreign Application Priority Data
Mar. 31, 2021 (JP) 2021-061172

(51) Int. Cl. E02F 9/26; E02F 9/24; G06F 3/14; H04N 7/18

(52) U.S. Cl. CPC E02F 9/261; E02F 9/24; G06F 3/14; H04N 7/185; E02F 9/2285

(57) ABSTRACT

A construction machine includes a detector configured to detect a moving object in a monitoring area within which an object is detected by a sensor provided on an upper revolving body; and a transmitter configured to transmit moving object information on the moving object detected by the detector to another construction machine in a work area.

### CROSS-REFERENCE TO RELATED APPLICATION

The present application is a continuation application of International Application No. PCT/JP2022/016306 filed on Mar. 30, 2022, which is based on and claims priority to Japanese Patent Application No. 2021-061172, filed on Mar. 31, 2021. The contents of these applications are incorporated herein by reference in their entirety.

### TECHNICAL FIELD

The present disclosure relates to a construction machine and a support system of construction machine.

### BACKGROUND

In recent years, a construction machine has been known that obtains information on a work area and transmits the information obtained by an obtainment unit to another construction machine.

In the conventional technique described above, there is no description of the case where a moving object is present in the work area, and it is difficult to cause the operator of the construction machine to grasp presence of a moving object approaching the construction machine.

### SUMMARY

According to an embodiment of the present invention, a construction machine includes a detector configured to detect a moving object in a monitoring area within which an object is detected by a sensor provided on an upper revolving body; and a transmitter configured to transmit moving object information on the moving object detected by the detector to another construction machine in a work area.

According to an embodiment of the present invention, a support system of construction machines includes a plurality of construction machines positioned within a predetermined work area, wherein each of the plurality of construction machines includes a detector configured to detect a moving object in a monitoring area within which an object is detected by a sensor provided on an upper revolving body, and a transmitter configured to transmit moving object information on the moving object detected by the detector to another construction machine in the work area.

According to an embodiment of the present invention, a support system of construction machines includes a plurality of construction machines positioned within a predetermined work area within which an object is detected by a sensor provided on an upper revolving body; a detector configured to detect a moving object in a monitoring area; and a reproducer configured to reproduce, in time series, information on the moving object in the work area, based on the moving object information on the moving object detected by the detector.

### BRIEF DESCRIPTION OF THE DRAWINGS

FIG. 1 is a schematic diagram illustrating an example of a configuration of an excavator support system;

FIG. 2 is a top view of an excavator;

FIG. 3 is a configuration diagram illustrating an example of a configuration of an excavator;

FIG. 4 is a diagram illustrating a functional configuration of a controller of the excavator;

FIG. 5 is a diagram illustrating an example of an object detection method;

FIG. 6A is a diagram illustrating a situation at a construction site;

FIG. 6B is a diagram illustrating a situation at a construction site;

FIG. 7 is a diagram illustrating moving object information in a monitoring area;

FIG. 8 is a first flow chart illustrating a process of the controller;

FIG. 9 is a second flow chart illustrating the process of the controller;

FIG. 10 is a first diagram illustrating a display example; and

FIG. 11 is a second diagram illustrating a display example.

### EMBODIMENTS

In the following, embodiments will be described with reference to the drawings. According to an embodiment of the present invention, the safety of a work site can be improved.

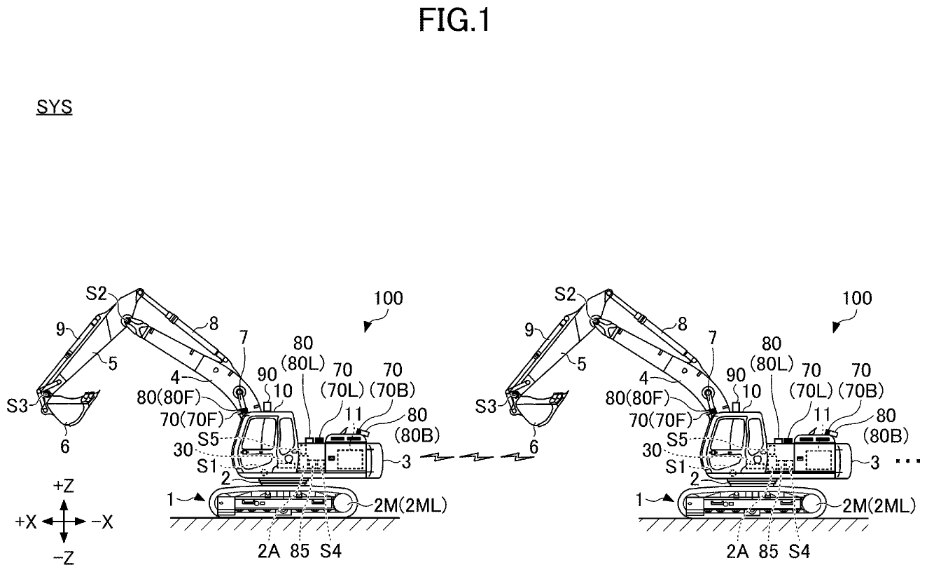

FIG. 1 illustrates an excavator support system SYS as an example of a support system of construction machines. The respective embodiments described in the following can also be applied to an excavator, a wheel loader, a bulldozer, or the like as a construction machine.

FIG. 1 is a schematic diagram illustrating an example of a configuration of an excavator support system SYS.

The excavator support system SYS includes multiple excavators 100 arranged at a relatively short distance from each other (e.g., that execute work at the same work site (work area)), and supports work executed by each of the excavators 100. In the following, the description will proceed on the assumption that each of the multiple excavators 100 has the same configuration with respect to the excavator support system SYS.

The excavator 100 (an example of a construction machine) includes a traveling lower body 1; a revolving upper body 3 mounted on the traveling lower body 1, to be capable of revolving via a revolution mechanism 2; a boom 4, an arm 5, and a bucket 6 constituting an attachment; and a cabin 10.

The traveling lower body 1 includes a pair of crawlers 1C on the left and right, specifically, a left hydraulic motor for traveling 1CL and a right hydraulic motor for traveling 1CR. By having the left hydraulic motor for traveling 1CL and the right hydraulic motor for traveling 1CR that are hydraulically driven by hydraulic motors for traveling 2M (2ML and 2MR), the traveling lower body 1 causes the excavator 100 to travel.

The revolving upper body 3 is driven by a hydraulic motor for revolution 2A, and revolves with respect to the traveling lower body 1. Alternatively, the revolving upper body 3 may be electrically driven by an electric motor, instead of hydraulically driven by the hydraulic motor for revolution 2A. In the following, for the sake of convenience, a side of the revolving upper body 3 on which the attachment AT is attached is defined as the forward direction, and the side on which the counterweight is attached is defined as the backward direction.

The boom 4 is attached to the center of the front part of the revolving upper body 3, to be capable of being elevated; at the tip of the boom 4, the arm 5 is attached to be capable of rotating upward or downward; and at the tip of the arm 5, the bucket 6 is attached to be capable of rotating upward or downward. The boom 4, the arm 5, and the bucket 6 are hydraulically driven by a boom cylinder 7, an arm cylinder 8, and a bucket cylinder 9 as hydraulic actuators, respectively.

The cabin 10 is a cab boarded by the operator, and is mounted on the left side of the front part of the revolving upper body 3.

The excavator 100 can establish a connection state, for example, a peer-to-peer (P2P) connection, in which the excavator 100 can communicate with another excavator 100 by short-range wireless communication of a predetermined method based on a predetermined communication protocol such as Bluetooth (registered trademark) communication or Wi-Fi (registered trademark) communication. Accordingly, the excavator 100 can obtain various items of information from the other excavator 100, and transmit various items of information to the other excavator 100. Details will be described later.

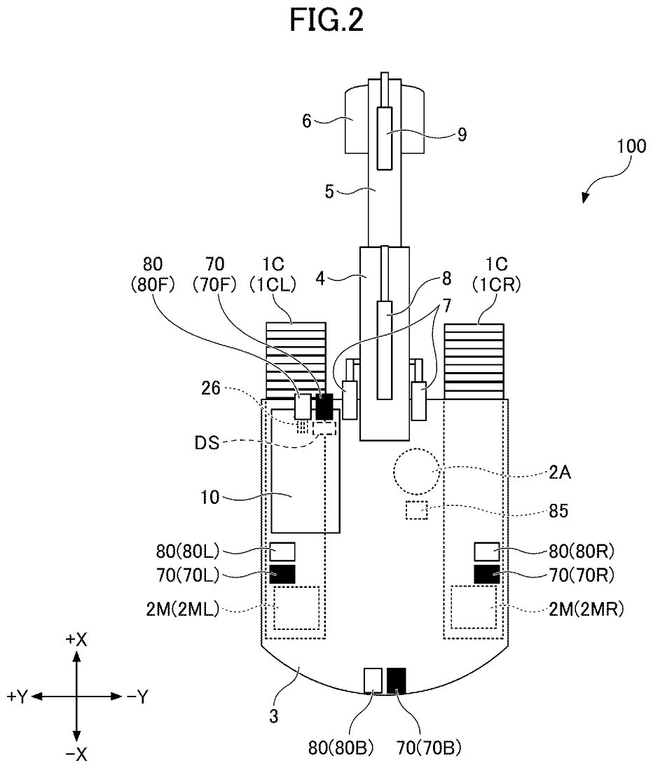

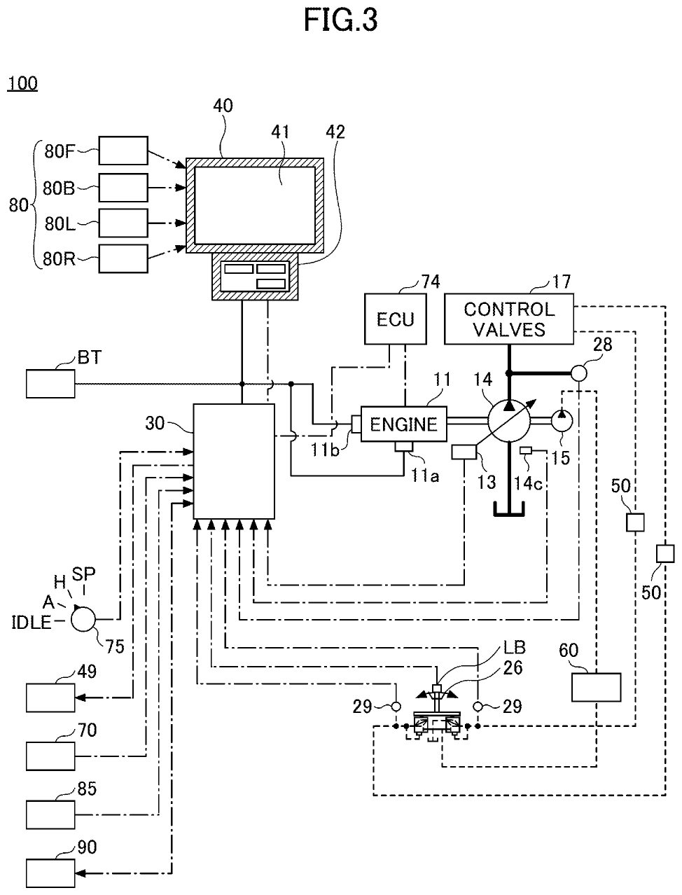

Next, in addition to FIG. 1, with reference to FIGS. 2 and 3, a specific configuration of the excavator 100 of the excavator support system SYS will be described.

FIG. 2 is a top view of the excavator 100. FIG. 3 is a configuration diagram illustrating an example of a configuration of the excavator 100.

As described above, the excavator 100 includes, as the elements of the hydraulic system, hydraulic actuators including the hydraulic motors for traveling 2M (2ML and 2MR), the hydraulic motor for revolution 2A, the boom cylinder 7, the arm cylinder 8, the bucket cylinder 9, and the like. In addition, the excavator 100 includes, as the elements of the hydraulic system, an engine 11, regulators 13, main pumps 14, an oil temperature sensor 14c, a pilot pump 15, control valves 17, an operation device 26, a discharge pressure sensor 28, an operation pressure sensor 29, pressure reducing valves 50, and a control valve 60.

In addition, the excavator 100 includes, as the elements of the control system, the controller 30 (control unit), an engine control unit (ECU) 74, an engine revolutions per minute (RPM) adjustment dial 75, a boom angle sensor S1, an arm angle sensor S2, a bucket angle sensor S3, a machine tilt sensor S4, a revolution state sensor S5, a warning device 49, an object detection device 70, an imaging device 80, an orientation detection device 85, a communication device 90, a display device 40, a lever button LB.

The engine 11 is the main power source of the hydraulic system, and is installed, for example, in the rear part of the revolving upper body 3. Specifically, the engine 11 revolves constantly at a predetermined target RPM set in advance, to drive the main pumps 14 and the pilot pump 15, under control of the ECU 74. The engine 11 is, for example, a diesel engine fueled with light oil.

The regulators 13 control the discharge amount of the main pumps 14. For example, in response to a control command from the controller 30, the regulators 13 adjust the angle of the swashplate (hereafter, “tilt angle”) of the main pumps 14.

The main pumps 14, for example, like the engine 11, are mounted in the rear part of the revolving upper body 3, to supply hydraulic oil to the control valves 17 through high pressure hydraulic lines, when being driven by the engine 11 as described above. Each of the main pumps 14 is, for example, a variable displacement hydraulic pump, and as described above, has the tilt angle of its swashplate adjusted by a regulator 13 under control of the controller 30; accordingly, the stroke length of the piston is adjusted, and thereby, the discharge flow (discharge pressure) is controlled.

The oil temperature sensor 14c detects the temperature of the hydraulic oil flowing into the main pump 14. A detection signal corresponding to the detected temperature of the hydraulic oil is taken into the controller 30.

The pilot pump 15 is installed, for example, in the rear part of the revolving upper body 3, to supply pilot pressure to the operation device 26 via pilot lines. The pilot pump 15 is, for example, a fixed-capacity hydraulic pump, and driven by the engine 11 as described above.

Each of the control valves 17 is a hydraulic control device that is installed, for example, in the center part of the revolving upper body 3 for controlling the hydraulic actuators in response to an operation performed on the operation device 26 by the operator. As described above, the control valves 17 are connected to the main pumps 14 via high pressure hydraulic lines, and selectively supply the hydraulic oil supplied from the main pumps 14 to the hydraulic actuators (the hydraulic motors for traveling 2ML and 2MR, the hydraulic motor for revolution 2A, the boom cylinder 7, the arm cylinder 8, and the bucket cylinder 9), depending on the operational state (contents of an operation) of the operation device 26.

The operation device 26 is an operation input part provided around the cockpit in the cabin 10 for the operator to perform operations on various elements to be driven (the traveling lower body 1, the revolving upper body 3, the boom 4, the arm 5, the bucket 6, and the like). In other words, the operation device 26 is an operation input part for the operator to perform operations on the elements to be driven that drive the respective hydraulic actuators (i.e., the hydraulic motors for traveling 2ML and 2MR, the hydraulic motor for revolution 2A, the boom cylinder 7, the arm cylinder 8, and the bucket cylinder 9). The operation device 26 is connected to the control valves 17 via pilot lines on its secondary side.

This allows the control valves 17 to receive as input pilot pressures depending on the operational states of the traveling lower body 1, the revolving upper body 3, the boom 4, the arm 5, the bucket 6, and the like in the operation device 26. Therefore, the control valves 17 can selectively drive the respective hydraulic actuators depending on the operational state in the operation device 26.

The discharge pressure sensors 28 detect the discharge pressures of the main pumps 14. Detection signals corresponding to the discharge pressures detected by the discharge pressure sensors 28 are taken into the controller 30.

Each of the operational pressure sensors 29 detects a pilot pressure on the secondary side of the operation device 26, namely, the pilot pressure (hereafter, “operational pressure”) corresponding to the operational state (i.e., operational contents) related to each element to be driven (i.e., hydraulic actuator) in the operation device 26. Detection signals of pilot pressures corresponding to operational states of the traveling lower body 1, the revolving upper body 3, the boom 4, the arm 5, the bucket 6, and the like in the operation device 26 detected by the operational pressure sensors 29 are taken into the controller 30.

The pressure reducing valve 50 is provided on a pilot line on the secondary side of the operation device 26, i.e., a pilot line between the operation device 26 and the control valve 17, and adjusts (reduces) a pilot pressure corresponding to an operation content (operation amount) on the operation device 26 under control of the controller 30. Accordingly, the controller 30 can control (limit) operations of the various elements to be driven by controlling the pressure reducing valve 50.

The control valve 60 switches an operation on the operation device 26, i.e., an operation of the various elements to be driven of the excavator 100, between an enabled state and a disabled state. The control valve 60 is, for example, a gate lock valve configured to operate in response to a control command from the controller 30. Specifically, the control valve 60 is arranged on a pilot line between the pilot pump 15 to the operation device 26, and switches the pilot line between a communicating state and a cut-off (non-communicating) state in response to a control command from the controller 30.

For example, when a gate lock lever provided in the vicinity of the entrance of the cockpit of the cabin 10 is pulled up, the gate lock valve transitions into a communication state in which an operation on the operation device 26 is enabled (operable state), whereas when the gate lock lever is pushed down, the gate lock valve transitions into a cutoff state in which an operation on the operation device 26 is disabled (inoperable state). Therefore, the controller 30 can limit (stop) operations of the excavator 100 by outputting a control command to the control valve 60.

The controller 30 is, for example, a control device that is attached inside the cabin 10, to drive and control the excavator 100. The controller 30 operates with power supplied from a storage battery BT. In the following, the display device 40 and various sensors (e.g., the object detection device 70, the imaging device 80, the boom angle sensor S1, and the like) similarly operate by the power supplied from the storage battery BT. The storage battery BT is charged with electric power generated by an alternator 11b driven by the engine 11.

Functions of the controller 30 may be implemented with any hardware components, a combination of the hardware components and software components, or the like.

For example, the controller 30 is configured primarily with a computer that includes a CPU (Central Processing Unit), a memory device such as a RAM (Random Access Memory), a non-volatile auxiliary storage device such as a ROM (Read-Only Memory), an input/output interface device with the outside, and the like. In this case, the controller 30 can implement various functions by reading one or more programs stored (installed) in the auxiliary storage device, loading the programs into the memory device, and executing the programs on the CPU.

Note that some of the functions of the controller 30 may be implemented by another controller (control device). In other words, the functions of the controller 30 may be implemented in a way of being distributed among multiple controllers.

For example, the controller 30 controls the regulator 13 and the like, based on detection signals taken in from various sensors such as the boom angle sensor S1, the arm angle sensor S2, the bucket angle sensor S3, the discharge pressure sensor 28, and the operation pressure sensor 29.

In addition, for example, in the case where an object to be monitored (a person, a truck, another construction machine, or the like) is detected by the object detection device 70 in a predetermined monitoring area in the surroundings of the excavator 100 (an area within 5 meters from the excavator 100), the controller 30 executes control of avoiding contact or the like between the excavator 100 and the object to be monitored (hereafter, referred to as “contact avoidance control”).

Specifically, as an example of the contact avoidance control, the controller 30 may output a control command to the warning device 49 to output a warning. In addition, as an example of the contact avoidance control, the controller 30 may limit an operation of the excavator 100 by outputting a control command to the pressure reducing valve 50 or the control valve 60. At this time, the target of the operation restriction may be all the elements to be driven or may be only part of the elements to be driven necessary for avoiding contact between the object to be monitored and the excavator 100.

In addition, for example, in the case where the object detection device 70 detects an object that is moving in a monitoring area in the surroundings of the excavator 100, the controller 30 obtains information on this object. In the following description, an object that is moving will be referred to as a moving object, and information on the moving object will be referred to as the moving object information. The moving object may be a person, a vehicle, and the like. The moving object information on the present embodiment includes positional information, a traveling direction, a moving speed, and the like of the moving object.

Once having obtained the moving object information, based on the traveling direction of the moving object included in the moving object information, the controller 30 identifies another excavator 100 as the transmission destination of the moving object information, and transmits the moving object information to the identified other excavator 100 via the communication device 90 (an example of a transmitter).

The other excavator 100 is, for example, a construction machine that works in the same work site (work area) as the excavator 100.

In addition, in response to receiving the moving object information from the other excavator 100 via the communication device 90 (an example of a receiver), the controller 30 according to the present embodiment causes the display device 40 to display information indicating presence of a moving object approaching the excavator 100 from the outside of the monitoring area of the excavator 100. The process executed by the controller 30 will be described in detail later.

The ECU 74 drives and controls the engine 11 under control of the controller 30. For example, in response to an ignition-on operation, the ECU 74 appropriately controls a fuel injection device and the like according to an operation of a starter 11a driven by the electric power from the storage battery BT, to start the engine 11. In addition, for example, the ECU 74 appropriately controls the fuel injection device and the like so as to cause the engine 11 revolves constantly at the set RPM designated by a control signal from the controller 30 (isochronous control).

Note that the engine 11 may be directly controlled by the controller 30. In this case, the ECU 74 may be omitted.

The RPM adjustment dial 75 is an operation unit for adjusting the RPM of the engine 11 (hereafter, referred to as the “engine RPM”). The setting state of the engine RPM output from the RPM adjustment dial 75 is taken into the controller 30. The RPM adjustment dial 75 is configured to be capable of switching the engine RPM in four stages of an SP (Super Power) mode, an H (Heavy) mode, an A (Auto) mode, and an idling mode.

The SP mode is a mode of the RPM of the engine to be selected in the case where it is desirable to prioritize the work rate, in which the RPM of the engine is set to the highest target RPM. The H mode is a mode of the RPM of the engine to be selected in the case where it is desirable to balance the work rate and the fuel efficiency, in which the RPM of the engine is set to the second highest target RPM.

The A mode is a mode of the RPM of the engine to be selected in the case where it is desirable to operate the excavator 100 with low noise while prioritizing the fuel efficiency, in which the RPM of the engine is set to the third highest target RPM.

The idling mode is a mode of the RPM of the engine to be selected in the case where it is desirable to shift the engine into an idling state, in which the RPM of the engine is set to the lowest target RPM. The engine 11 is controlled under the ECU 74, so as to operate constantly at a target RPM corresponding a mode of the RPM of the engine set by the RPM adjustment dial 75.

The boom angle sensor S1 is attached to the boom 4, to detect an elevation angle θ1 of the boom 4 with respect to the revolving upper body 3 (referred to as the “boom angle”, hereafter). For example, the boom angle θ1 is an angle of elevation from a state of the boom 4 being descended most.

In this case, the boom angle θ1 becomes maximum when the boom 4 comes to the highest position. The boom angle sensor S1 may include, for example, a rotary encoder, an acceleration sensor, a hexaxial sensor, an IMU (Inertial Measurement Unit), and the like, and in the following, the same applies to the arm angle sensor S2, the bucket angle sensor S3, and the machine tilt sensor S4.

In addition, the boom angle sensor S1 may be a stroke sensor attached to the boom cylinder 7, and in the following, the same applies to the arm angle sensor S2 and the bucket angle sensor S3. A detection signal corresponding to the boom angle θ1 detected by the boom angle sensor S1 is taken into the controller 30.

The arm angle sensor S2 is attached to the arm 5, to detect an angle of rotation θ2 of the arm 5 with respect to the boom 4 (referred to as the “arm angle”, hereafter). For example, the arm angle 92 is an angle of opening from a state of the arm 5 being closed most. In this case, the arm angle θ2 becomes maximum when the arm 5 is opened to the maximum. A detection signal corresponding to the arm angle detected by the arm angle sensor S2 is taken into the controller 30.

The bucket angle sensor S3 is attached to the bucket 6, to detect an angle of rotation θ3 of the bucket 6 with respect to the arm 5 (referred to as the “bucket angle”, hereafter). The bucket angle θ3 is an angle of opening from a state of the bucket 6 being closed most. In this case, the bucket angle θ3 becomes maximum when the bucket 6 is opened most. A detection signal corresponding to the bucket angle detected by the bucket angle sensor S3 is taken into the controller 30.

The machine tilt sensor S4 detects the tilt state of a body (e.g., the revolving upper body 3) with respect to a predetermined plane (e.g., the horizontal plane). The machine tilt sensor S4 is attached to, for example, the revolving upper body 3, to detect biaxial tilt angles (referred to as the “back-and-forth tilt angle” and the “left-and-right tilt angle”, hereafter) of the excavator 100 (i.e., the revolving upper body 3) in the back-and-forth direction and in the left-and-right direction. Detection signals corresponding to the tilt angles (the back-and-forth tilt angle and the left-and-right tilt angle) by the machine tilt sensor S4 are taken into the controller 30.

The revolution state sensor S5 is attached to the revolving upper body 3, and outputs detected information on the revolution state of the revolving upper body 3. The revolution state sensor S5 detects, for example, the revolutional angular velocity and the revolution angle of the revolving upper body 3. The revolution state sensor S5 includes, for example, a gyro sensor, a resolver, a rotary encoder, and the like.

Note that in the case where the machine tilt sensor S4 includes a gyro sensor, a hexaxial sensor, an IMU, or the like capable of detecting angular velocity around three axes, the revolving state (e.g., revolutional angular velocity) of the revolving upper body 3 may be detected based on the detection signal of the machine tilt sensor S4. In this case, the revolution state sensor S5 may be omitted.

The warning device 49 calls attention of a person involved in the work of the excavator 100 (e.g., an operator in the cabin 10, a worker in the surroundings of the excavator 100, or the like). The warning device 49 includes, for example, an indoor warning device for calling attention of the operator or the like inside the cabin 10.

The indoor warning device includes, for example, at least one of a sound output device, a vibration generating device, and a light emitting device provided in the cabin 10. In addition, the indoor warning device may include the display device 40. In addition, the warning device 49 may include an outdoor warning device for calling attention of workers and the like outside the cabin 10 (e.g., in the surroundings of the excavator 100).

The outdoor warning device includes, for example, at least one of a sound output device and a light emitting device provided outside the cabin 10. The sound output device may be, for example, a traveling alarm device attached to the bottom surface of the revolving upper body 3. The outdoor warning device may be a light emitting device provided on the revolving upper body 3. For example, in the case where an object to be monitored is detected by the object detection device 70 in the monitoring area, as described above, the warning device 49 may notify the detection to a person engaged in the work of the excavator 100, under control of the controller 30.

The object detection device 70 is configured to detect an object present in the surroundings of the excavator 100. Objects to be detected include, for example, a person, an animal, a vehicle, a construction machine, a building, a wall, a fence, a hole, and the like. The object detection device 70 includes, for example, at least one of a monocular camera (an example of a camera), an ultrasonic sensor, a millimeter-wave radar, a stereo camera, a LIDAR (Light Detecting and Ranging), a range image sensor, an infrared sensor, and the like. In other words, the object detection device 70 outputs to the controller 30 information for detecting a predetermined object present within a predetermined region set in the surroundings of the excavator 100.

In the following description, information output from the object detection device 70 to the controller 30 may be referred to as environmental information.

In addition, the object detection device 70 may output a form in which the type of object can be distinguished, for example, information in a form by which a person can be distinguished from an object other than a person, to the controller 30 as part of the environmental information.

Based on a predetermined model such as a pattern recognition model or a machine learning model that takes as input, for example, the environmental information obtained by the object detection device 70, the controller 30 detects a predetermined object and distinguishes the type of object.

Note that in the present embodiment, the object detection device 70 may detect a predetermined object or distinguishes the type of object, based on a predetermined model such as a pattern recognition model or a machine learning model that takes as input the environmental information.

The object detection device 70 includes a forward sensor 70F, a backward sensor 70B, a left sensor 70L, and a right sensor 70R. A signal corresponding to a detection result of the object detection device 70 (the forward sensor 70F, the backward sensor 70B, the left sensor 70L, and the right sensor 70R) are input into the controller 30.

The forward sensor 70F is attached to, for example, the front end on the upper surface of the cabin 10, to detect an object present in front of the revolving upper body 3. The backward sensor 70B is attached to, for example, the rear end on the upper surface of the revolving upper body 3, to detect an object present behind the revolving upper body 3.

The left sensor 70L is attached to, for example, the left end on the upper surface of the revolving upper body 3, to detect an object present on the left of the revolving upper body 3. The right sensor 70R is attached to, for example, the right end on the upper surface of the revolving upper body 3, to detect an object present on the right of the revolving upper body 3.

Note that the object detection device 70 may only obtain the environmental information in the surroundings of the excavator 100 that serves as the basis for object detection (e.g., data of a captured image, or a reflected wave with respect to a detection wave such as a millimeter wave or a laser transmitted to the surroundings, etc.), a specific process of detecting an object, a process of distinguishing the type of an object, and the like may be executed by a device outside the object detection device 70 (e.g., the controller 30).

The imaging device 80 captures an image of the surroundings of the excavator 100, and outputs the captured image. The imaging device 80 includes a forward camera 80F, a backward camera 80B, a left camera 80L, and a right camera 80R.

An image captured by the imaging device 80 (any of the forward camera 80F, the backward camera 80B, the left camera 80L, and the right camera 80R) is taken into the display device 40. In addition, the captured image obtained by the imaging device 80 is taken into the controller 30 via the display device 40. Alternatively, the captured image obtained by the imaging device 80 may be taken into the controller 30 directly without going through the display device 40.

The forward camera 80F is attached, for example, to the front end of the upper surface of the cabin 10 so as to be adjacent to the forward sensor 70F, to image a situation in front of the revolving upper body 3. The backward camera 80B is attached, for example, to the back end of the upper surface of the revolving upper body 3 so as to be adjacent to the backward sensor 70B, to image a situation behind the revolving upper body 3.

The left camera 80L is attached, for example, to the left end of the upper surface of the revolving upper body 3 so as to be adjacent to the left sensor 70L, to image a situation on the left side of the revolving upper body 3. The right camera 80R is attached, for example, to the right end of the upper surface of the revolving upper body 3 so as to be adjacent to the right sensor 70R, to image a situation on the right side of the revolving upper body 3.

Note that in the case where the object detection device 70 includes an imaging device such as a monocular camera or a stereo camera, part or all of the functions of the imaging device 80 may be integrated into the object detection device 70. For example, in the case where the imaging device is included in the forward sensor 70F, the functions of the forward camera 80F may be integrated into the forward sensor 70F. The same applies to the functions of the backward sensor 70B, the left sensor 70L, and the right sensor 70R in the case where an imaging device is included in each of the backward camera 80B, the left camera 80L, and the right camera 80R.

The orientation detection device 85 is configured to detect information on a relative relationship between the orientation of the revolving upper body 3 and the orientation of the traveling lower body 1 (hereafter, referred to as “information on the orientation”). For example, the orientation detection device 85 may be configured with a combination of a geomagnetic sensor attached to the traveling lower body 1 and a geomagnetic sensor attached to the revolving upper body 3.

Alternatively, the orientation detection device 85 may be configured with a combination of a GNSS (Global Navigation Satellite System) receiver attached to the traveling lower body 1 and a GNSS receiver attached to the revolving upper body 3.

In the case of adopting a configuration where the revolving upper body 3 is driven by a motor generator, the orientation detection device 85 may be configured with a resolver attached to the motor generator. Also, the orientation detection device 85 may be arranged, for example, in a center joint provided in connection with the revolution mechanism 2 to implement relative revolution between the traveling lower body 1 and the revolving upper body 3. Information detected by the orientation detection device 85 is taken into the controller 30.

The communication device 90 is any device that executes short-range communication of a predetermined method with various devices in a work area (work site) (e.g., a management device that measures and manages positional information on other construction machines, workers, and the like in the work area); other excavators 100 in the surroundings of the excavator 100; and the like. The management device is, for example, a terminal device installed in a temporary office or the like in a work site of the excavator 100.

The terminal device may be, for example, a stationary terminal device such as a desktop computer terminal, or may be a mobile terminal, for example, a smartphone, a tablet terminal, a laptop computer terminal, or the like. In addition, the management device may be, for example, an edge server installed in a temporary office or the like in a work site of the excavator 100 or in a place relatively close to the work site (e.g., a communication facility such as a station building or a base station near the work site).

In addition, the management device may be, for example, a cloud server installed in a facility such as a management center installed outside the work site of the excavator 100. The communication device 90 may be, for example, a Bluetooth (registered trademark) communication module, a Wi-Fi communication module, or the like.

The display device 40 is attached to a location readily visible from the operator seated on the cockpit in the cabin 10, to display various informative images. The display device 40 is, for example, a liquid-crystal display or an organic electroluminescence (EL) display.

For example, the display device 40 displays a captured image taken from the imaging device 80 or a converted image obtained by executing a predetermined conversion process on the captured image (a viewpoint converted image, a synthesized image obtained by synthesizing multiple captured images, or the like). The display device 40 includes an image display unit 41 and an input device 42.

The image display unit 41 is an area part for displaying an informative image in the display device 40. The image display unit 41 is configured with, for example, a liquid crystal panel, an organic EL panel, or the like.

The input device 42 receives an operation input on the display device 40. An operation input signal corresponding to an operation input into the input device 42 is taken into the controller 30. In addition, the input device 42 may receive various operation inputs related to the excavator 100 other than the display device 40.

The input device 42 includes, for example, a touch panel installed on a liquid crystal panel or an organic EL panel as the image display unit 41. In addition, the input device 42 may include any operation members such as a touch pad, a button, a switch, a toggle, and a lever that are separate from the image display unit 41.

Note that an operation input unit that receives various operation inputs related to the excavator 100 other than the display device 40 may be provided separately from the display device 40 (input device 42), for example, like the lever button LB.

The lever button LB is provided on the operation device 26, to receive a predetermined operation input related to the excavator 100. For example, the lever button LB is provided at the tip of an operation lever as the operation device 26. Accordingly, the operator or the like can operate the lever button LB while operating the operation lever (e.g., the operator or the like can press the lever button LB by the thumb in a state of gripping the operation lever with a hand).

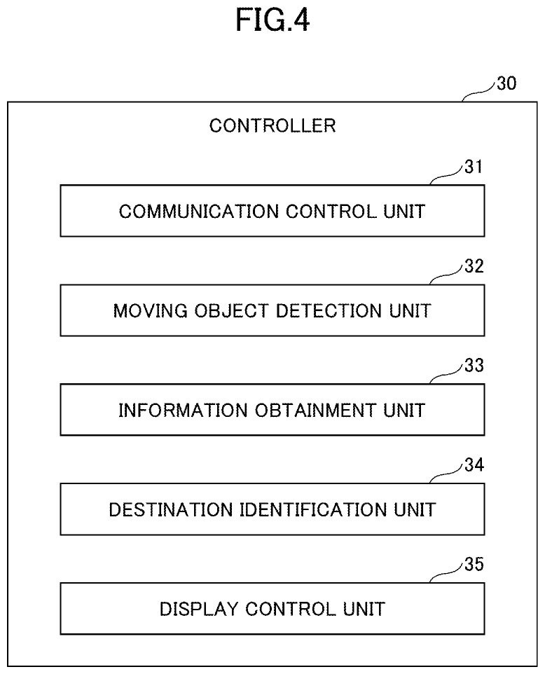

Next, with reference to FIG. 4, functions of the controller 30 according to the present embodiment will be described. FIG. 4 is a diagram illustrating a functional configuration of a controller of the excavator.

The controller 30 according to the present embodiment includes a communication control unit 31, a moving object detection unit 32 (a detector), an information obtainment unit 33, a destination identification unit 34, and a display control unit 35 (a display controller).

The communication control unit 31 controls communication between the excavator 100 and an EXT device via the communication device 90. Specifically, the communication control unit 31 controls communication between the excavator 100 and another excavator 100 via the communication device 90.

Based on the environmental information output from the object detection device 70, the moving object detection unit 32 determines whether a moving object to be monitored is detected in the monitoring area of the excavator 100. The monitoring area of the object detection device 70 is set to a range smaller than the imageable range of the object detection device 70.

In the case where a moving object is detected by the moving object detection unit 32, the information obtainment unit 33 obtains moving object information on the detected moving object. The moving object information on the present embodiment includes positional information, a moving speed, a traveling direction, a type of the moving object, and the like.

The destination identification unit 34 identifies another excavator 100 as the transmission destination of the moving object information, based on the moving object information obtained by the information obtainment unit 33. Specifically, the destination identification unit 34 identifies the other excavator 100 as the transmission destination of the moving object information, according to the traveling direction of the moving object included in the moving object information.

A method of obtaining the moving object information by the information obtainment unit 33 and a method of identifying the other excavator 100 by the destination identification unit 34 will be described in detail later.

In response to receiving by the communication control unit 31 the moving object information from the other excavator 100, the display control unit 35 displays information indicating that a moving object is approaching on the screen displayed on the display device 40.

In addition, in the case where a moving object identified by the received moving object information is detected in the monitoring area, the display control unit 35 switches, on the screen displayed on the display device 40, the information indicating that the moving object is approaching to the information indicating that the moving object is detected in the monitoring area.

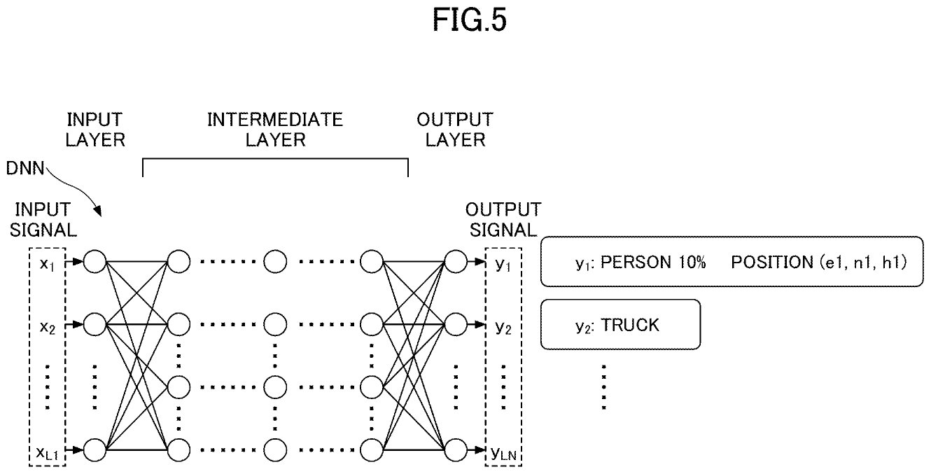

Next, with reference to FIGS. 5 to 7, a method of obtaining moving object information by the information obtainment unit 33 and a method of identifying a transmission destination by the destination identification unit 34 according to the present embodiment will be described.

FIG. 5 is a diagram illustrating an example of an object detection method.

As illustrated in FIG. 5, the moving object detection unit 32 according to the present embodiment detects an object in the surroundings of the excavator 100 by using a trained model configured mainly with a neural network DNN.

The neural network DNN is a what-is-called deep neural network that includes one or more intermediate layers (hidden layers) between an input layer and an output layer. In the neural network DNN, a weighting parameter representing a connection strength with a lower layer is defined for each of multiple neurons constituting each intermediate layer.

In addition, the neural network DNN is configured in a form such that the neurons of each layer output the sum of values obtained by multiplying input values from the multiple neurons of the upper layer by weighting parameters defined for each neuron of the upper layer to the neurons of the lower layer through a threshold function.

Machine learning, specifically, deep learning is executed on the neural network DNN to optimize the weighting parameters described above. Accordingly, the neural network DNN can receive as input environmental information (e.g., a captured image) obtained by the object detection device 70 as an input signal x, and output a probability (a prediction probability) that an object is present for each type of object corresponding to a predetermined monitoring target list, as an output signal y.

In the present embodiment, a signal y1 output from the neural network DNN indicates that the prediction probability that a ‘person’ is present in the surroundings of the excavator 100, i.e., within a range in which the environmental information can be obtained by the object detection device 70, is 10%.

The neural network DNN is, for example, a convolutional neural network (CNN). The CNN is a neural network to which existing image processing techniques (a convolution process and a pooling process) are applied.

Specifically, the CNN repeats a combination of a convolution process and a pooling process on the captured image obtained by the object detection device 70, to extract feature value data (feature map) having a size smaller than that of the captured image. In addition, a pixel value of each pixel of the extracted feature map is input into a neural network configured with multiple fully connected layers, and the output layer of the neural network can output, for example, a prediction probability that an object is present for each type of object.

In addition, the neural network DNN may have a configuration in which a captured image obtained by the object detection device 70 is input as the input signal x, and the position and size of an object in the captured image (i.e., an occupied area of the object on the captured image) and the type of object can be output as the output signal y.

In other words, the neural network DNN may be configured to execute detection of an object on a captured image (determination of an occupied area part of the object on the captured image) and determination of classification of the object. In addition, in this case, the output signal y may be configured in an image data format in which information on the occupied area of the object and the classification of the object is added to be superimposed to the captured image as the input signal x.

Accordingly, based on the position and size of the occupied area of an object in the captured image output from the trained model (neural network DNN), the moving object detection unit 32 can identify the relative position (distance and direction) of the object from the excavator 100. This is because the object detection device 70 (the forward sensor 70F, the backward sensor 70B, the left sensor 70L, and the right sensor 70R) is fixed to the revolving upper body 3, and the imaging range (angle of view) is defined (fixed) in advance.

In the present embodiment, a signal y1 output from the neural network DNN indicates that the position coordinates are ‘(e1, n1, h1)’ for an object present in the surroundings of the excavator 100, i.e., within a range in which the environmental information can be obtained by the object detection device 70. In other words, the obtainment range of the environmental information by the object detection device 70 is the monitoring area of the excavator 100.

In addition, the moving object detection unit 32 can determine that an object to be monitored is detected in the monitoring area in the case where the object detected by the trained model (neural network DNN) is in the monitoring area and is classified as an object in the monitoring target list.

The information obtainment unit 33 according to the present embodiment may obtain the signals y1 to yLN output from the neural network DNN as part of the moving object information.

For example, the neural network DNN may be configured to include a neural network corresponding to each of a process of extracting an occupied area (window) in which an object is present in a captured image, and a process of identifying the type of an object in the extracted area. In other words, the neural network DNN may be configured to detect an object and classify the object step by step.

In addition, for example, the neural network DNN may be configured to include neural networks corresponding to the respective processes of a process of defining classification of an object and an occupied area (bounding box) of the object for each grid cell obtained by dividing the entire area of a captured image into a predetermined number of partial areas; and a process of combining occupied areas of objects by types based on classification of the objects by grid cells, to determine final occupied areas of the objects. In other words, the neural network DNN may be configured to detect an object and classify the object in parallel.

The moving object detection unit 32 calculates a prediction probability for each type of object on the captured image, for example, for every predetermined control period. Upon calculating the prediction probability, if the current determination result matches the previous determination result, the moving object detection unit 32 may further increase the current prediction probability.

For example, in the case where, with respect to the prediction probability that an object appearing in a predetermined area on a captured image is determined to be a ‘person’ (y1) in the previous object detection process, the object is continuously determined to be a ‘person’ (y1) in the current process, the prediction probability that the object is determined to be a ‘person’ (y1) in the current process may be further increased.

Accordingly, for example, in the case where the determination result on the classification of an object related to the same image area is continuously consistent, the prediction probability is calculated to be relatively higher. Therefore, the object detection device 70 can suppress erroneous determination such that even though an object of the type is present as a matter of fact, the prediction probability of the object of the type is determined to be relatively low due to some noise.

In addition, the moving object detection unit 32 may execute determination of an object on a captured image in consideration of operations of the excavator 100 such as traveling and revolving. This is because, even in the case where an object in the surroundings of the excavator 100 is stationary, the position of the object on a captured image may move due to traveling or revolving of the excavator 100, and the object may not be recognized as the same object.

For example, due to traveling or revolving of the excavator 100, the image area determined to be a ‘person’ (y1) in the current process may be different from the image area determined to be a ‘person’ (y1) in the previous process. In this case, in the case where the image area determined to be a ‘person’ (y1) in the current process is within a predetermined range from the image area determined to be a ‘person’ (y1) in the previous process, the moving object detection unit 32 may regard the image area as the same object, and execute continuous matching determination (i.e., determination of a state in which the same object is continuously detected).

In the case of executing continuous matching determination, the moving object detection unit 32 may include an image area within a predetermined range from this image area, in addition to the image area used in the previous determination, in the image area used in the current determination. Accordingly, even if the excavator 100 is traveling or revolving, the moving object detection unit 32 can execute continuous matching determination with respect to the same object in the surroundings of the excavator 100.

In addition, the moving object detection unit 32 may detect an object in the surroundings of the excavator 100 by using any object detection method based on machine learning other than the method using the neural network DNN.

For example, in the present embodiment, with respect to the multivariate local feature value obtained from a captured image of the object detection device 70, a trained model representing a boundary for distinguishing (classifying), for each type of object, a range of an object of the type and a range of an object not of the type in the multivariate space may be generated by supervised training.

The method of machine learning (supervised training) applied to generation of information on the boundary may be, for example, a support vector machine (SVM), a k-nearest neighbor method, a mixed Gaussian distribution model, or the like. Accordingly, based on the trained model, the object detection device 70 can detect an object based on whether the local feature value obtained from the captured image is in a range that is a predetermined type of object or in a range that is not a predetermined type of object.

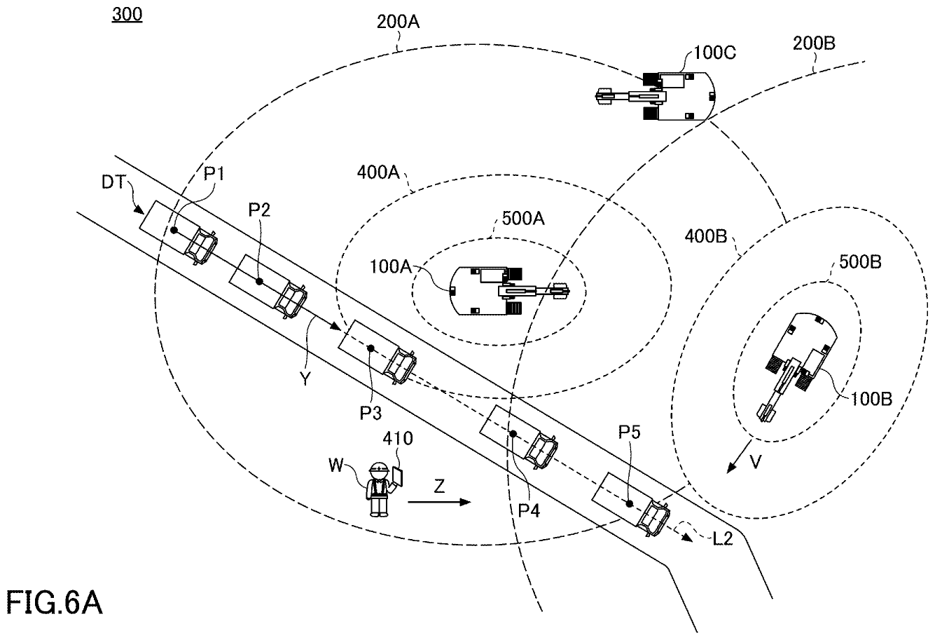

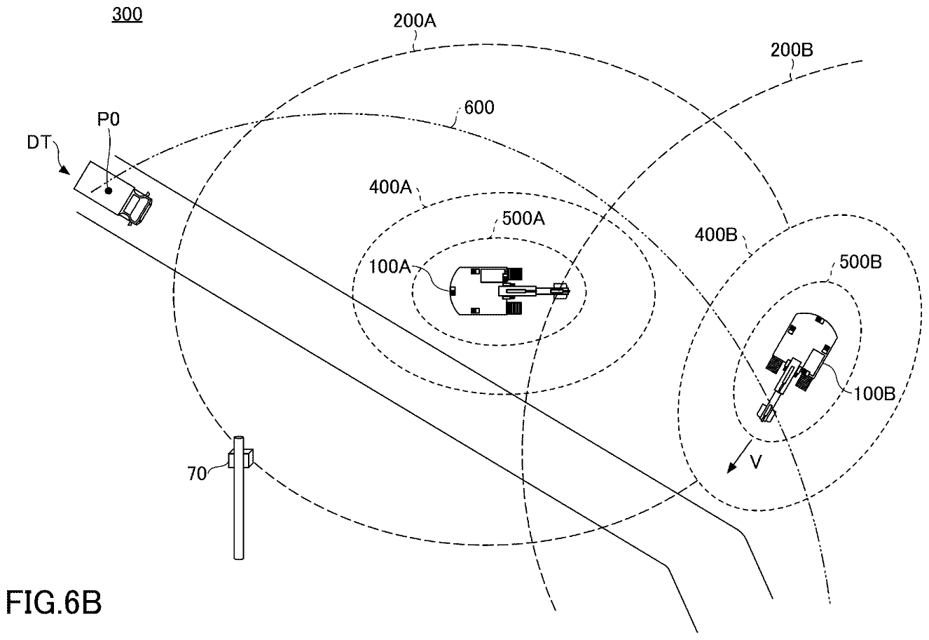

Next, with reference to FIGS. 6A and 6B, an overview of operations of the excavator 100 according to the present embodiment will be described. FIG. 6A is a first diagram illustrating an overview of operations of the excavator.

In FIG. 6A, a state of an excavator 100A, an excavator 100B, and an excavator 100C are working in a work area 300 is illustrated. The work area 300 is, for example, a work site in which the excavator 100A, the excavator 100B, and the excavator 100C work in the same hours. In addition, in FIG. 6A, a state is illustrated in which, in the work area 300, the excavator 100A is traveling in the Y direction as the traveling direction, the excavator 100B is traveling in the V direction as the traveling direction, and the excavator 100C is stopped. Note that the work area 300 according to the present embodiment is not limited to a work site, and may be any place as long as multiple excavators 100 can execute work in the same hours.

The area 200A illustrated FIG. 6A is a monitoring area in which an object can be detected using the object detection device 70 of the excavator 100A. In addition, the area 200B is a monitoring area in which an object can be detected using the object detection device 70 of the excavator 100B. In other words, the work area in the present embodiment is an area including the monitoring area of the excavator 100 and wider than the monitoring area.

In the following description, in the case where the excavator 100A, the excavator 100B, and the excavator 100C are not distinguished from one another, these may be referred to as the excavator(s) 100; and in the case where the monitoring areas 200A and 200B are not distinguished from each other, these may be referred to as the monitoring area(s) 200.

In the present embodiment, a caution area 400 and an operation stop area 500 are set inside the monitoring area 200 with a setting of the excavator 100 being at the center.

The caution area 400 is a range set for outputting information calling attention of the operator of the excavator 100. Once an object detected by the object detection device 70 of the excavator 100 enters the caution area 400, the controller 30 outputs information calling attention.

The information calling attention may be displayed on the display device 40 or may be output as a sound, a warning sound, or the like.

The operation stop area 500 is a range set further inside the caution area 400, and is a range set for stopping operations of the excavator 100. Once an object detected by the object detection device 70 of the excavator 100 enters the operation stop area 500, the controller 30 stops operations of the excavator 100.

Note that in the present embodiment, even in the case where an object enters the operation stop area 500, if the controller 30 determines that the operation of the excavator 100 is an operation not related to contact with the object, the controller 30 may permit this operation.

The caution area 400 and the operation stop area 500 according to the present embodiment may be set in advance. In addition, the caution area 400 and the operation stop area 500 according to the present embodiment may be set to change, for example, depending on the type of operation of the excavator 100.

FIG. 6A illustrates a state in which a dump truck DT is moving from the inside of the monitoring area 200A of the excavator 100A to approach the excavator 100B. Specifically, in the example in FIG. 6A, the dump truck DT starts from a point P1 at a time t1, passes through a point P2 at a time t2, and reaches a point P3 at a time t3. Here, the point P1 to a point P5 are within the monitoring area 200A of the excavator 100A, and the point P3 is within a caution area 400A of the excavator 100A. Further, the points P4 and P5 are within a monitoring area 200B of the excavator 100B.

Further, in the example in FIG. 6A, in the monitoring area 200A of the excavator 100A, a worker W moves in a Z direction intersecting the traveling direction of the excavator 100A. In addition, the excavator 100B is arranged in the monitoring area 200A of the excavator 100A, and is traveling in a V direction as the traveling direction.

In such a case, the excavator 100A according to the present embodiment executes a process by the moving object detection unit 32 for each predetermined control period by the moving object detection unit 32, to output the positional information on the dump truck DT in the monitoring area 200A from the time t1 to the time t5. Further, the excavator 100A outputs positional information indicating the positions of the excavators 100B and 100C and the worker W in the monitoring area 200A. The positional information on the worker W may be obtained through communication between a support device 410 carried by the worker W and the excavator 100A, or may be detected by the object detection device 70.

In addition, the excavator 100A obtains by the information obtainment unit 33 the positional information output from the moving object detection unit 32, and identifies the moving speed and the traveling direction (moving direction) of the dump truck DT, based on the positional information on the dump truck DT at the respective times. Similarly, the excavator 100A identifies the moving speed and the traveling direction (moving direction) of the excavator 100B and the worker W.

In addition, in the excavator 100A according to the present embodiment, once the traveling direction (Y direction) of the dump trucks DT in the monitoring area 200A is identified by the information obtainment unit 33, the destination identification unit 34 identifies another excavator 100 whose monitoring area includes a line L2 indicating the Y direction from among the other excavators 100B and 100C included in the monitoring area 200A.

Note that in the present embodiment, assume that the excavators 100 present in the work area 300 share positional information indicating the positions of the respective excavators 100. The positional information on the excavator 100 may be obtained by a global positioning system (GPS) function included in the excavator 100.

In the example in FIG. 6A, the monitoring area 200B of the excavator 100B includes the line L2 indicating the Y direction as the traveling direction of the dump trucks DT. Therefore, the destination identification unit 34 of the excavator 100A identifies the excavator 100B as a transmission destination of the moving object information. In addition, similarly, the destination identification unit 34 of the excavator 100A identifies the worker W moving in the Z direction intersecting the Y direction, which is the traveling direction of the dump trucks DT, as another transmission destination of the moving object information. Specifically, the destination identification unit 34 of the excavator 100A may identify the support device 410 held by the worker W as the transmission destination of the moving object information.

In the present embodiment, in this way, a trajectory along which the moving object moves is predicted from the traveling direction of the moving object identified in the monitoring area 200A of the excavator 100A, and the transmission destination (excavator 100B) of the moving object information is identified according to the predicted result.

In addition, in the case where multiple moving objects are present in the monitoring area 200A, the excavator 100A may identify the transmission destination of the moving object information based on the traveling direction of each moving object. Specifically, for example, in the case where the traveling direction (Y direction) of the dump truck DT which is the moving object present in the monitoring area 200A intersects with the traveling direction (V direction) of the excavator 100B traveling in the monitoring area 200A, the excavator 100B may be identified as the transmission destination of the moving object information.

In other words, the controller 30 of the excavator 100 may identify the other excavator 100, based on the traveling direction of the other excavator 100 in the monitored area and the traveling direction (moving direction) of the moving object in the monitored area. In addition, the controller 30 may determine not only the traveling direction (moving direction (orientation)) of the moving object, but also the speed of the moving object.

Therefore, according to the present embodiment, an approach of a moving object (the dump truck DT) can be notified to the other excavators 100 in the work area 300, and the safety during work can be improved.

In addition, the destination identification unit 34 of the excavator 100A may set a predetermined range with reference to a line indicating the traveling direction of the moving object, to identify the excavator 100 included in the set predetermined range as the transmission destination of the moving object information. The destination identification unit 34 of the excavator 100A can identify the excavator 100B within a predetermined range from the trajectory, as the excavator to be set as the transmission destination for the moving object information, based on a trajectory (a line indicating the traveling direction) of the moving object predicted from the traveling direction of the moving object in the monitoring area 200A.

In response to receiving the moving object information from the excavator 100A, the excavator 100B predicts an area in the monitoring area 200B which the moving object enters, and causes the display device 40 of the excavator to display a marker or the like at the predicted position, based on the positional information and the traveling direction of the moving object indicated by the moving object information. In other words, in response to receiving the moving object information, the excavator 100B causes the display device 40 to display information indicating that the moving object information is received.

Once the dump truck enters the monitoring area 200B, the excavator 100B detects the dump truck DT by the moving object detection unit 32. In addition, once detecting entry of the dump truck DT, the excavator 100B switches the display of the marker or the like on the display device 40 to an image indicating the detected moving object.

In this way, in the present embodiment, in response to receiving the moving object information from the other excavator 100, information identifying a direction in which the moving object enters is displayed on the display device 40 based on the moving object information. Therefore, according to the present embodiment, an approach of a moving object from the outside of the monitoring area 200B can be notified (alerted, displayed, etc.) to the operator of the excavator 100B, and the safety can be improved. The notification may be executed by outputting a warning from the indoor warning device. In addition, the notification may be executed by causing the display device 40 to display information indicating the approach of the moving object. Further, in the case where the excavator 100B is connected to the dump trucks DT through communication, the approach between the moving objects may also be notified to the dump trucks DT.

Note that in the example in FIG. 6A, although a state in which the monitoring area 200A and the monitoring area 200B have an overlapping area is illustrated, the present invention is not limited as such. There may be no overlapping area between the monitoring area 200A and the monitoring area 200B.

Next, with reference to FIG. 6B, another example of operations of the excavator 100 according to the present embodiment will be described. FIG. 6B is a second diagram illustrating an overview of operations of the excavator.

In FIG. 6B, a case is illustrated in which the object detection device 70 is installed on a utility pole, a steel tower, or the like in a work area 300. In this case, the object detection device 70 can be arranged at a higher position than the position at which the object detection device 70 would be provided in the excavator 100, and the monitoring area can be set to cover a wider range.

In the example in FIG. 6B, it can be seen that a monitoring area 600 of the object detection device 70 installed on the utility pole or the like is wider than the monitoring area 200 of the object detection device 70 provided on the excavator 100.

Environmental information output from the object detection device 70 installed in the utility pole or the like is transmitted to the management device of the excavator 100 or the excavator 100 arranged in the work area 300. Therefore, the management device or the controller 30 can obtain a wider range of environmental information than the environmental information output from the object detection device 70 installed on the excavator 100.

Therefore, the management device or the controller 30 can recognize the positional relationship between multiple objects such as the dump truck DT and the excavator 100 more quickly.

Further, in the example in FIG. 6B, the functions of the moving object detection unit 32 may be provided in the object detection device 70 installed in ta utility pole or the like. In this case, the object detection device 70 outputs information indicating whether a moving object is detected to the management device or the controller 30 together with the environmental information. Therefore, in the example in FIG. 6B, presence or absence of a moving object outside the monitoring area 200 of the excavator 100 can be notified to the management device or the controller 30.

In FIG. 6B, assume that the dump truck DT is traveling from a point P0 toward the inside of the monitoring area 200A. The point P0 is positioned outside the monitoring area 200A, yet within the monitoring area 600 of the object detection device 70. Therefore, in this case, the object detection device 70 can detect the approach of the dump truck DT to the monitoring area 200A, and notify the presence of the dump truck DT to the excavator 100A before the dump truck DT enters the monitoring area 200A.

In addition, in the work area, multiple utility poles each provided with the object detection device 70 may be installed. Further, in the case where the utility poles or the like each provided with the object detection device 70 are installed at multiple locations in the work area, the monitoring areas 600 of adjacent object detection devices 70 may overlap. In this way, in the case where the utility poles or the like each provided with the object detection device 70 are installed at multiple locations in the work area, the entire range of a construction area can be included in the monitoring area. In addition, even if a detected moving object stops in the work area, the moving object detection unit 32 may continuously recognize the stopped moving object as the moving object.

Note that in FIG. 6B, the excavator 100A may obtain the positional information on the worker W and the excavator 100B, as in the FIG. 6A.

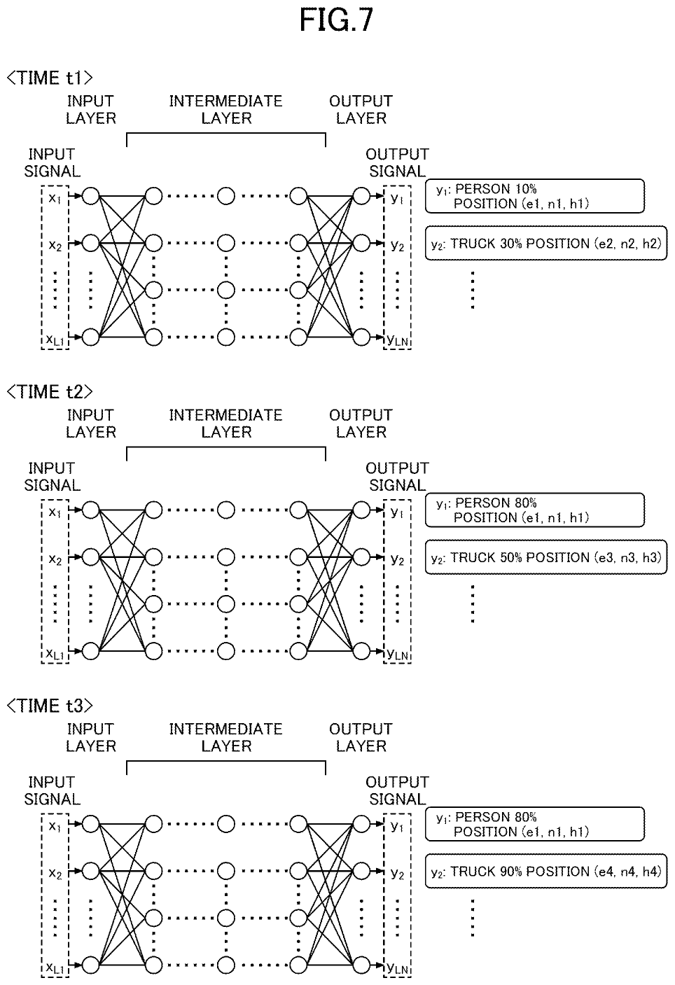

FIG. 7 is a diagram illustrating moving object information in a monitoring area. In FIG. 7, illustrates an example of signals output from the neural network DNN at the times t1, t2, and t3.

In other words, FIG. 7 illustrates an example of part of the moving object information output from the moving object detection unit 32 to the information obtainment unit 33 at each of the times t1, t2, and t3.

At each of the times t1, t2, and t3, the moving object detection unit 32 of the excavator 100A outputs signals output from the neural network DNN to the information obtainment unit 33.

Among the signals y1 to yLN output from the neural network DNN at each of the times t1, t2, and t3, the output signal y2 includes the probability that an object detected in the monitoring area 200A is a truck and the position of the object as the positional information.

Specifically, according to the output signal y2 at the time t1, the probability that an object is a truck is 30%, and the coordinates of this object are (e2, n2, h2); and according to the output signal y2 at the time t2, the probability that an object is a truck is 50% and the coordinates of this object are (e3, n3, h3). In addition, according to the output signal y2 at the time t3, the probability that an object is a truck is 90% and the coordinates of this object are (e4, n4, h4).

The moving object detection unit 32 according to the present embodiment detects that the object is a moving object from the coordinates of the object being changed at the respective times.

In addition, the information obtainment unit 33 according to the present embodiment calculates the moving speed and the traveling direction of this object from the positional information on the object at the respective times. In addition, the information obtainment unit 33 transmits the moving object information that includes the information indicating the type of moving object obtained from the moving object detection unit 32, the positional information on the moving object, and the moving speed and the traveling direction of the object to the excavator 100B identified by the destination identification unit 34.

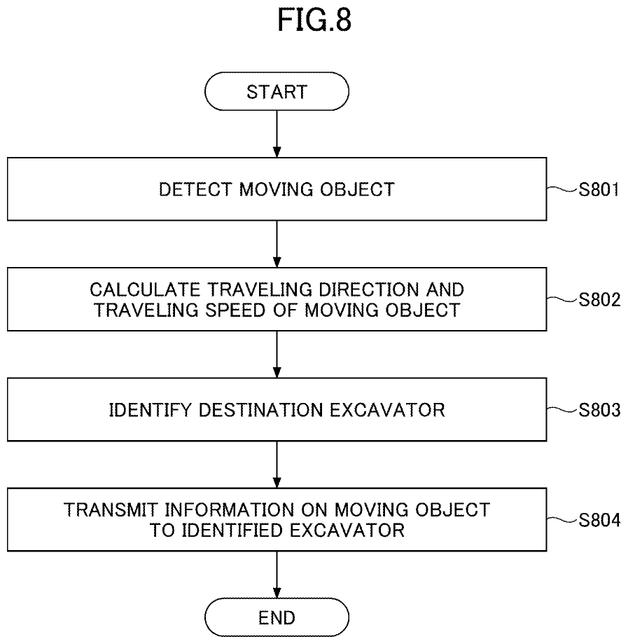

Next, with reference to FIG. 8, a process of the controller 30 executed when the excavator 100 according to the present embodiment transmits the moving object information to the other excavator 100 will be described. FIG. 8 is a first flow chart illustrating a process of the controller.

The controller 30 of the excavator 100 according to the present embodiment detects a moving object in the monitoring area from the environmental information obtained from the object detection device 70 by the moving object detection unit 32 (Step S801).

Next, the controller 30 obtains the positional information on the moving object at each time from the moving object detection unit 32 by the information obtainment unit 33, and calculates the traveling direction and the moving speed of the moving object (Step S802); at this time, the information obtainment unit 33 obtains the moving object information that includes the positional information on the moving object, the traveling direction, the moving speed, the type of moving object, and the like.

Next, based on the traveling direction calculated by the information obtainment unit 33, the controller 30 identifies another excavator 100 as a transmission destination of the moving object information (Step S803).

Next, the controller 30 causes the communication control unit 31 to transmit the moving object information obtained by the information obtainment unit 33 to the other excavator 100 identified by the destination identification unit 34 (Step S804), and ends the process of transmitting the moving object information.

Note that the moving object information according to the present embodiment may include at least the positional information and the traveling direction of the moving object, and may not include the type of moving object and the moving speed.

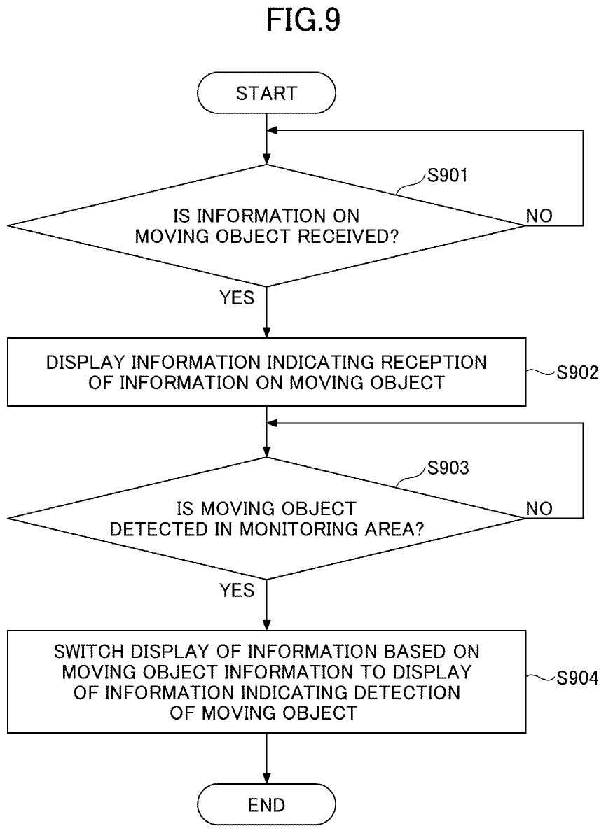

Next, with reference to FIG. 9, a process executed by the excavator 100 according to the present embodiment in the case of receiving the moving object information from the other excavator 100 will be described.

FIG. 9 is a second flow chart illustrating the process of the controller. The excavator 100 according to the present embodiment determines by the communication control unit 31 whether the moving object information is received from the other excavator 100 (Step S901). At Step S901, if the moving object information is not received, the controller 30 stands by.

At Step S901, if the moving object information is received, the controller 30 causes the display control unit 35 to display information indicating that the moving object information is received on the image display unit 41 of the display device 40 (Step S903).

Next, the controller 30 determines whether a moving object is detected in the monitoring area by the moving object detection unit 32 (Step S904). At Step S904, if no moving object is detected, the controller 30 stands by.

At Step S904, if a moving object is detected, the controller 30 causes the display control unit 35 to switch the information to be displayed on the image display unit 41 from the information indicating that the moving object information is received, to the information indicating that the moving object is detected (Step S905).

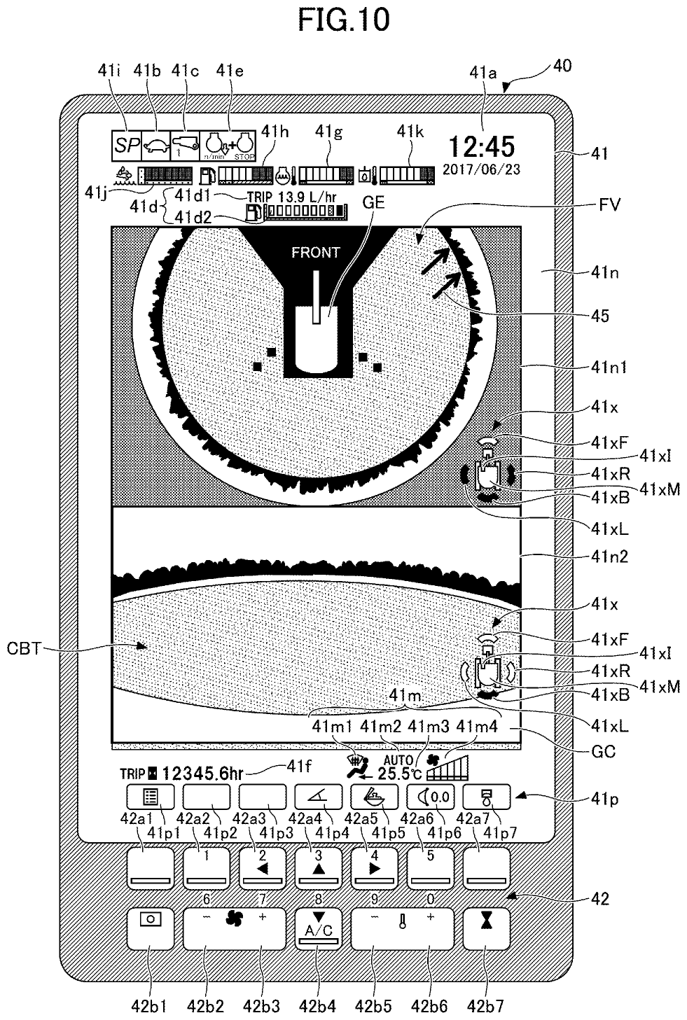

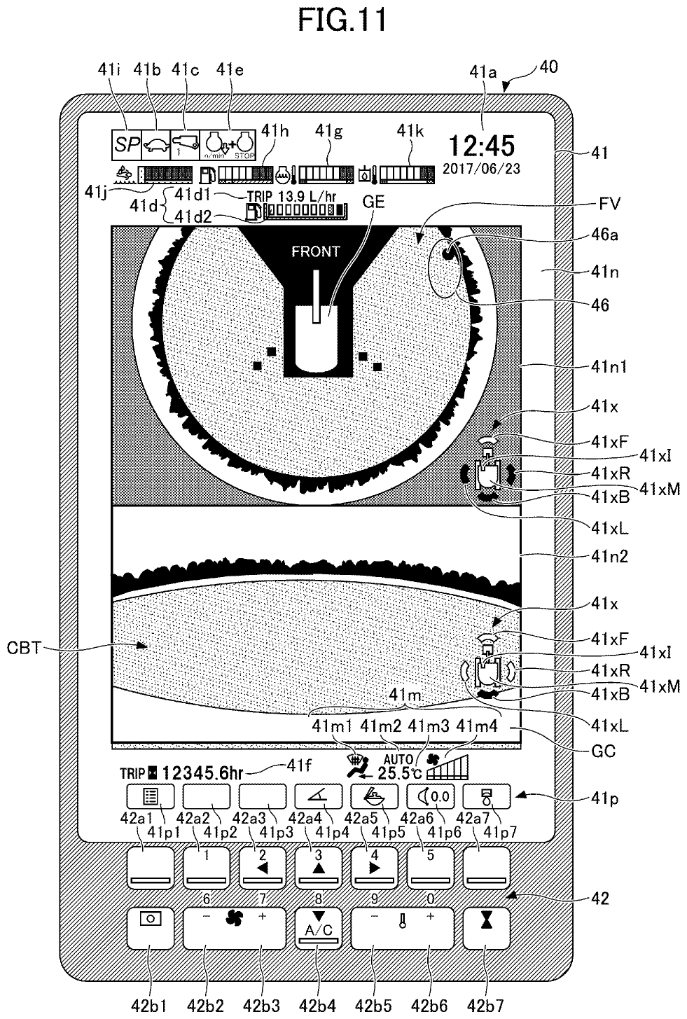

In the following, with reference to FIGS. 10 and 11, a display example of the display device 40 will be described. FIG. 10 is a first diagram illustrating a display example.

The display device 40 illustrated in FIG. 10 has a main screen displayed on the image display unit 41. In addition, the main screen illustrated in FIG. 10 is, for example, a screen displayed on the display device 40 at Step S902 in FIG. 9, and an image 45 as information indicating that the moving object information is received from the other excavator 100 is displayed.

First, the image display unit 41 will be described. As illustrated in FIG. 10, the image display unit 41 includes a date and time display area 41a, a traveling mode display area 41b, an attachment display area 41c, a fuel efficiency display area 41d, an engine control state display area 41e, an engine working hours display area 41f, a cooling water temperature display area 41g, a remaining fuel display area 41h, an RPM display area 41i, a remaining urea water display area 41j, a hydraulic oil temperature display area 41k, an air-conditioner operating state display area 41m, an image display area 41n, and a menu display area 41p.

The traveling mode display area 41b, the attachment display area 41c, the engine control state display area 41e, the RPM display area 41i, and the air-conditioner operating state display area 41m are areas that display setting state information as information on the setting states of the excavator 100. The fuel efficiency display area 41d, the engine working hours display area 41f, the cooling water temperature display area 41g, the remaining fuel display area 41h, the remaining urea water display area 41j, and the hydraulic oil temperature display area 41k are areas to display operational state information as information on the operational states of the excavator 100.

Specifically, the date and time display area 41a is an area to display the current date and time. The traveling mode display area 41b is an area to display the current traveling mode. The attachment display area 41c is an area to display an image representing the end attachment currently attached. The fuel efficiency display area 41d is an area to display information on fuel efficiency calculated by the controller 30. The fuel efficiency display area 41d includes an average fuel efficiency display area 41d1 to display the lifetime average fuel efficiency or the interval average fuel efficiency, and an instantaneous fuel efficiency display area 41d2 to display the instantaneous fuel efficiency.

The engine control state display area 41e is an area to display the control state of the engine 11. The engine working hours display area 41f is an area to display the cumulative operating hours of the engine 11. The cooling water temperature display area 41g is an area to display the current temperature condition of the engine cooling water. The remaining fuel display area 41h is an area to display the state of the remaining amount of fuel stored in the fuel tank.

The RPM display area 41i is an area to display the current mode of RPM set by the engine RPM adjustment dial 75. The remaining urea water display area 41j is an area to display the remaining state of urea water stored in the urea water tank. The hydraulic oil temperature display area 41k is an area to display the temperature condition of hydraulic oil in the hydraulic oil tank.

The air-conditioner operating state display area 41m includes an air outlet display area 41m1 for displaying a current position of an air outlet; a driving mode display area 41m2 for displaying a current driving mode; a temperature display area 41m3 for displaying a currently set temperature; and an air flow display area 41m4 for displaying a currently set air flow.

The image display area 41n is an area to display an image captured by the imaging device S6. In the example in FIG. 4, the image display area 41n displays a bird's eye view image FV and a backward image CBT. The bird's eye view image FV is, for example, a virtual viewpoint image generated by the display control unit 35, and is generated based on respective images obtained by the backward camera S6B, the left camera S6L, and the right camera S6R.

In addition, an excavator graphic GE corresponding to the excavator 100 is arranged in a central part of the bird's eye view image FV. This is to allow the operator to more intuitively grasp the positional relationship between the excavator 100 and an object present in the surroundings of the excavator 100. The backward image CBT is an image projecting a space behind the excavator 100 and includes an image GC of the counterweight. The backward image CBT is a real viewpoint image generated by the control unit 40a, and is generated based on an image obtained by the backward camera S6B.

In addition, the image display area 41n has a first image display area 41n1 positioned on the upper side and a second image display area 41n2 positioned on the lower side. In the example in FIG. 10, the bird's eye view image FV is arranged in the first image display area 41n1, and the backward image CBT is arranged in the second image display area 41n2. However, in the image display area 41n, the bird's eye view image FV may be arranged in the first image display area 41n2, and the backward image CBT may be arranged in the second image display area 41n1.

In addition, in the example in FIG. 10, the bird's eye view image FV and the backward image CBT are arranged to be vertically adjacent to each other, but may be arranged with spacing therebetween. In addition, in the example in FIG. 10, although the image display area 41n is a vertically long area, the image display area 41n may be a horizontally long area.

In the case where the image display area 41n is a horizontally long area, the image display area 41n may have the bird's eye view image FV arranged on the left side as the first image display area 41n1, and the backward image CBT arranged on the right side as the second image display area 41n2. In this case, the images may be arranged with spacing to be separated on the left and right, or the positions of the bird's eye view image FV and the backward image CBT may be exchanged.

The menu display area 41p includes tabs 41p1 to 41p7. In the example in FIG. 7, the tabs 41p1 to 41p7 are arranged at the lowermost part of the image display unit 41, to be apart from each other in the left-right direction. Icon images for displaying various items of information are displayed in the tabs 41p1 to 41p7.

In the tab 41p1, an icon image of detailed menu items for displaying detailed menu items is displayed. Once the tab 41p1 is selected by the operator, the icon image displayed from the tab 41p2 to the tab 41p7 is switched to the icon image associated with the detailed menu items.

In the tab 41p4, an icon image for displaying information on a digital level is displayed. Once the tab 41p4 is selected by the operator, the backward image CBT is switched to a screen presenting information on the digital level. However, the information on the digital level may be displayed by being superimposed on the backward image CBT or by reducing the backward image CBT.

In addition, the bird's eye view image FV may be switched to a screen presenting the information on the digital level, or a screen presenting the information on the digital level may be displayed by being superimposed on the bird's eye view image FV or by reducing the bird's eye view image FV.

In the tab 41p5, an icon image for transitioning the main screen displayed on the image display unit 41 to a loading operation screen is displayed. Once the operator selects the input device 42 corresponding to the tab 41p5 that will be described later, the main screen displayed on the image display unit 41 transitions to a loading operation screen. Note that at this time, the image display area 41n is continuously displayed, and the menu display area 41p is switched to an area for displaying information on the loading work.

In the tab 41p6, an icon image for displaying, information on information-oriented construction is displayed. Once the tab 41p6 is selected by the operator, the backward image CBT is switched to a screen presenting the information on information-oriented construction. However, the information on information-oriented construction may be displayed by being superimposed on the backward image CBT or by reducing the backward image CBT. In addition, the bird's eye view image FV may be switched to a screen presenting the information on information-oriented construction, or a screen presenting the information on the digital level may be displayed by being superimposed on the bird's eye view image FV or by reducing the bird's eye view image FV.

In the tab 41p7, an icon image for displaying information on crane mode is displayed. Once the tab 41p7 is selected by the operator, the backward image CBT is switched to a screen presenting the information on the crane mode. However, the information on the crane mode may be displayed by being superimposed on the backward image CBT or by reducing the backward image CBT. In addition, the bird's eye view image FV may be switched to a screen presenting the information on the crane mode, or a screen presenting the information on the crane mode may be displayed by being superimposed on the bird's eye view image FV or by reducing the bird's eye view image FV.

No icon image is displayed in the tabs 41p2 and 41p3. Therefore, even if the operator operates the tabs 41p2 and 41p3, the image displayed on the image display unit 41 does not change.

Note that the icon images displayed on the tabs 41p1 to 41p7 are not limited to the examples described above, and icon images for displaying other information items may be displayed.

Next, the input device 42 will be described. As illustrated in FIG. 10, the input device 42 is configured with one or multiple button-type switches through which the operator selects the tabs 41p1 to 41p7 and inputs settings.

In the example in FIG. 10, the input device 42 includes seven switches 42al to 42a7 arranged in an upper row and seven switches 42b1 to 42b7 arranged in a lower row. The switches 42b1 to 42b7 are arranged below the switches 42a1 to 42a7, respectively.

However, the number, form, and arrangement of the switches of the input device 42 are not limited to the example described above; for example, the functions of multiple button-type switches may be integrated into one by a jog wheel, a jog switch, or the like, or the input device 42 may be separated from the display device 40. In addition, a touch panel in which the image display unit 41 and the input device 42 are integrated may be used for directly operating the tab 41p1 to 41p7.

The switches 42a1 to 42a7 are arranged below the tabs 41p1 to 41p7 so as to correspond to the tabs 41p1 to 41p7, respectively, and each switch functions as a switch for selecting the corresponding one of the tabs 41p1 to 41p7.

The switches 42a1 to 42a7 are arranged below the tabs 41p1 to 41p7 so as to correspond to the tabs 41p1 to 41p7, respectively; therefore, the operator can intuitively select the tabs 41p1 to 41p7.

In FIG. 10, for example, once the switch 42a1 is operated, the tab 41p1 is selected, the menu display area 41p is changed from a single-row display to a double-row display, and the icon images corresponding to the first menu are displayed in the tabs 41p2 to 41p7. In addition, in accordance with the change of the menu display area 41p from the single-row display to the double-row display, the size of the backward image CBT is reduced. At this time, as the size of the bird's eye view image FV is maintained without being changed, the visibility when the operator confirms the surroundings of the excavator 100 does not deteriorate.

The switch 42b1 is a switch for switching the captured image displayed in the image display area 41n. The captured image displayed in the first image display area 41n1 of the image display area 41n is configured to be switched every time the switch 42b1 is operated, for example, among a backward image, a left image, a right image, and a bird's eye view image.

In addition, the captured image displayed in the second image display area 41n2 of the image display area 41n may be configured to be switched every time the switch 42b1 is operated, for example, among a backward image, a left image, a right image, and a bird's eye view image.

In addition, in response to an operation on the switch 42b1, the display control unit 35 may change display forms of the images 41xF, 41xB, 41xL, 41xR, and 41xI in the icon image 41x.

In addition, it may be configured such that, every time the switch 42b1 is operated, the captured image displayed in the first image display area 41n of the image display area 41n1 and the captured image displayed in the second image display area 41n2 are exchanged.

In this way, the switch 42b1 as the input device 42 may switch the screen displayed in the first image display area 41n1 or the second image display area 41n2, or may switch the screen displayed in the first image display area 41n1 or the second image display area 41n2. In addition, a switch for switching the screen displayed in the second image display area 41n2 may be provided separately.

The switches 42b2 and 42b3 are switches for adjusting the air flow of the air conditioner. In the example in FIG. 10, these are configured such that when the switch 42b2 is operated, the air flow of the air conditioner is decreased, and when the switch 42b3 is operated, the air flow of the air conditioner is increased.

The switch 42b4 switches between on and off of the cooling/heating function. In the example in FIG. 10, it is configured to switch on and off of the cooling/heating function every time the switch 42b4 is operated.

The switches 42b5 and 42b6 are switches for adjusting the setting temperature of the air conditioner. In the example in FIG. 10, when the switch 42b5 is operated, the setting temperature is lowered, and when the switch 42b6 is operated, the setting temperature is raised.

The switch 42b7 is a switch capable of switching the display of the engine working hours display area 41f.

In addition, the switches 42a2 to 42a6 and 42b2 to 42b6 are configured to be capable of inputting numbers displayed on or near the respective switches. In addition, the switches 42a3, 42a4, 42a5, and 42b4 are configured to move a cursor leftward, upward, rightward, and downward, respectively, when the cursor is displayed on the menu screen.

Note that the functions assigned to the switches 42a1 to 42a7 and 42b1 to 42b7 are merely examples, and these may be configured to execute other functions.

As described above, once the tab 411 is selected in a state where the bird's eye view image FV and the backward image CBT are displayed in the image display area 41n, detailed items of the first menu are displayed in the tabs 41p2 to 41p7 in a state where the bird's eye view image FV and the backward image CBT are displayed. Therefore, the operator can confirm the detailed items of the first menu while confirming the bird's eye view image FV and the backward image CBT.

In addition, in the image display area 41n, the bird's eye view image FV is displayed without changing the size before and after the tab 41p1 is selected. The visibility when the operator confirms the surroundings of the excavator 100 does not deteriorate.

Further, in the present embodiment, information indicating that the moving object information is received is displayed on the bird's eye view image FV displayed in the image display area 41n. In the example in FIG. 10, as the information indicating that the moving object information is received, the image 45 is displayed on the bird's eye view image FV.

In FIG. 10, the display control unit 35 predicts an area where the moving object enters in the monitoring area of the excavator 100, based on the positional information and the traveling direction of the moving object included in the moving object information. In addition, the display control unit 35 displays the image 45 for identifying the predicted area on the bird's eye view image FV. In the example in FIG. 10, it can be seen that the moving object enters the monitoring area in the right direction of the excavator 100.

Note that in the example in FIG. 10, although the image 45 is displayed as an example of the information indicating that the moving object information is received, the display form of the information indicating that the moving object information is received is not limited to the example in FIG. 10.

The display control unit 35 may display a message or the like indicating that the moving object information is received, or may display an icon image, a three dimensional model image, or the like indicating an approach of the moving object on the outer periphery of the bird's eye view image FV.

In addition, the controller 30 may output information indicating that the moving object information is received as sound. In the case where the moving object is output as sound, a direction which the moving object enters, a predicted entrance time, or the like may be output.

FIG. 11 is a second diagram illustrating a display example. After receiving the moving object information from the other excavator 100 and displaying the image 45, once a moving object is detected based on the environmental information obtained by the object detection device 70 of the excavator 100, the excavator 100 according to the present embodiment switches the display in the image display area 41n.

Specifically, the display control unit 35 hides the image 45, and displays an image 46 indicating the area where the moving object is detected based on the environmental information obtained by the object detection device 70 and the image 46a schematically indicating the moving object so as to be superimposed on the bird's eye view image FV.

In the present embodiment, in this way, by displaying the information indicating that the moving object information is received from the other excavator 100 together with the bird's eye view image FV, it is possible to notify the presence of the moving object approaching the excavator 100 from the outside of the monitoring area to the operator of the excavator 100. Further, in the present embodiment, based on the moving object information, an area where the moving object is entering the monitoring area can be notified to the operator. Therefore, according to the present embodiment, the operator can prepare for the approach of the moving object before the moving object enters the monitoring area, which can improve the safety. Note that although the controller 30 is installed on the excavator 100 in the embodiment described above, the controller 30 may be installed outside the excavator 100. In this case, the controller 30 may be, for example, a control device installed in a remote control room. In this case, the display device 40 may be connected to the control device provided in the remote control room. In addition, the control device installed in the remote control room may receive output signals from various sensors attached to the excavator 100, to detect a moving object in the monitored area. In addition, for example, in the embodiment described above, the display device 40 may function as a display unit in the support device 410. In this case, the support device 410 may be connected to the controller 30 of the excavator 100 or the controller installed in the remote control room.

In addition, the excavator support system SYS according to the present embodiment may include multiple excavators 100 and a management device for the excavators 100.

In the case where the management device is included in the excavator support system SYS, among the functions of the controller 30 of the excavator 100, the moving object detection unit 32, the information obtainment unit 33, the destination identification unit 34, and the display control unit 35 may be provided in the management device, and these functions may not be provided in the excavator 100.

In addition, the management device may include a reproduction unit (a reproducer) to reproduce the environmental information received from the object detection device 70. Based on the environmental information received from the object detection device 70, by the reproduction unit, the management device may cause the display device of the management device to display the state of the construction site illustrated in FIG. 6A and FIG. 6B. In this case, a construction manager can grasp the entire situation of the construction site by reproducing the positional relationship of the moving objects in the work site in time series. In this case, the management device may display each of the detected moving objects as an icon image, a three dimensional model, or the like. At this time, the management device may display information (warning, etc.) related to a notification to be issued to each moving object in a display area adjacent to the display area in which an icon image, a three dimensional model, or the like of each moving object is displayed. In addition, the management device may display each detected moving object as an icon image, a three dimensional model, or the like at a position corresponding to the positional information on the moving object on a construction planning drawing showing a construction plan. In addition, the management device may display each detected moving object as an icon image, a three dimensional model, or the like at a position corresponding to the positional information on the moving object on a construction progress drawing on which the latest information on the work site is reflected. In addition, the management device may display each detected moving object as an icon image, a three dimensional model, or the like at a position corresponding to the positional information on the moving object in the image of the work site obtained from the object detection device 70. In other words, the management device 200 includes a display control unit that displays an image of a moving object detected by the object detection unit 32 at a position corresponding to the positional information on the moving object, in the case where any one of the construction planning drawing, the construction progress drawing, and the image of the work site is displayed on the display device.

The reproduction unit may reproduce, for example, an image of the worksite included in the environmental information. Specifically, the reproduction unit may reproduce a video of the work area 300 captured by the object detection device 70. In addition, the reproduction unit may display (reproduce) multiple still images captured by the object detection device 70 in time series.

In particular, in the case where the object detection device 70 is arranged at a high place such as a steel tower or a utility pole, it is possible for the manager or the like of the work site to grasp the positional relationship of the objects of the entire work site. In addition, by reproducing the multiple still images in time series by the reproduction unit, the manager can grasp the positional relationship between the multiple moving objects in operation. Accordingly, the manager can improve the contents of work to improve the safety and the work efficiency. Further, in a reproducing display, the situation of the construction site displayed on the display device of the management device may be displayed on the display device 40 installed in the cabin 10 of the excavator 100.

In this way, the processing load of the controller 30 of the excavator 100 can be reduced. Specifically, in this case, the excavator 100 only needs to transmit the environmental information obtained by the object detection device 70 to the management device via the communication device 90 by the communication control unit 31, receive a command to display the information from the management device to the display device 40, and display the information. Note that in the example described above, although the management device is provided with the moving object detection unit 32, the information obtainment unit 33, the destination identification unit 34, and the display control unit 35 included in the controller 30 of the excavator 100, the management device is not limited as such. The moving object detection unit 32, the information obtainment unit 33, the destination identification unit 34, and the display control unit 35 may be provided to be distributed among the management device and the excavator 100. Specifically, for example, the excavator 100 may include the moving object detection unit 32, and the management device 200 may include the information obtainment unit 33, the destination identification unit 34, and the display control unit 35. In this case, upon detecting a moving object approaching the excavator 100 by the object detection unit 32, the excavator 100 may notify the detection to the management device.

As above, the embodiments have been described with reference to specific examples. However, the present invention is not limited to these specific examples. Appropriate design changes made to these specific examples by those skilled in the art are also included in the scope of the present invention as long as including the features of the present invention. Elements included in the specific examples described above and the arrangement, condition, shape, and the like of the elements are not limited to those exemplified and can be changed appropriately. The elements included in the specific examples described above may be appropriately combined as long as no technical contradiction occurs.

1. A construction machine comprising:
a detector configured to detect a moving object in a monitoring area within which an object is detected by a sensor provided on an upper revolving body; and
a transmitter configured to transmit moving object information on the moving object detected by the detector to another construction machine in a work area.

2. The construction machine as claimed in claim 1, wherein the moving object information includes, at least, positional information of the moving object, a moving speed of the moving object, a traveling direction of the moving object, or a type of the moving object.

3. The construction machine as claimed in claim 1, further comprising:
a receiver configured to receive, from said another construction machine, moving object information on a moving object detected in a monitored area of said another construction machine; and
a display controller including a memory and a processor configured to cause a display device to display information indicating that the moving object information is received from said another construction machine.

4. The construction machine as claimed in claim 3, wherein, in a case where the detector detects a moving object corresponding to the moving object information from said another construction machine, the display controller switches display of the information indicating that the moving object information is received, to display of information indicating that the moving object is detected.

5. The construction machine as claimed in claim 4, wherein the information indicating that the moving object information is received and the information indicating that the moving object is detected are displayed on a bird's eye view image displayed on the display device.

6. The construction machine as claimed in claim 5, wherein the information indicating that the moving object information is received is displayed at a position corresponding to an entering direction of the moving object into the monitoring area in the bird's eye view image.

7. The construction machine as claimed in claim 1, further comprising:
an object detection device that includes a sensor provided on the upper revolving body,
wherein the monitoring area is an area in which environmental information can be obtained by the object detection device.

8. A support system of construction machines comprising:
a plurality of construction machines positioned within a predetermined work area,
wherein each of the plurality of construction machines includes
a detector configured to detect a moving object in a monitoring area within which an object is detected by a sensor provided on an upper revolving body, and
a transmitter configured to transmit moving object information on the moving object detected by the detector to another construction machine in the work area.

9. A support system of construction machines comprising:
a plurality of construction machines positioned within a predetermined work area within which an object is detected by a sensor provided on an upper revolving body;
a detector configured to detect a moving object in a monitoring area; and
a reproducer configured to reproduce, in time series, information on the moving object in the work area, based on the moving object information on the moving object detected by the detector.

10. The support system of construction machines as claimed in claim 9, further comprising:
a notifier configured to, in a case where a plurality of moving objects are detected by the detector, and a moving object among the plurality of moving objects is approaching another moving object, notify approach of the moving object to one of said another moving object or a management device.

11. The support system of construction machines as claimed in claim 9, further comprising:
a display controller including a memory and a processor configured to display images of the plurality of moving objects detected by the detector at positions corresponding to positional information on the plurality of moving objects on a construction planning drawing showing a construction plan or a construction progress drawing displayed on a display device.

12. The support system of construction machines as claimed in claim 9, further comprising:
a display controller including a memory and a processor configured to display images of the plurality of moving objects detected by the detector at positions corresponding to positional information on the plurality of moving objects, in an image of the predetermined work area displayed on a display device.

13. The support system of construction machines as claimed in claim 9, wherein a moving object detector continues to detect the moving object while the moving object is stopped.

14. The construction machine as claimed in claim 2, wherein said another construction machine is identified using the traveling direction of the moving object.
